(19) United States
(12) Patent Application Publication
(10) Pub. No.: US 2025/0113873 A1
(43) Pub. Date: Apr. 10, 2025

(54) AEROSOL GENERATING DEVICE AND PAYMENT SYSTEM INCLUDING THE SAME

(71) Applicant: KT & G CORPORATION, Daejeon (KR)

(72) Inventors: Won Kyeong LEE, Gyeonggi-do (KR); Min Kyu KIM, Seoul (KR); Paul Joon SUNWOO, Seoul (KR)

(73) Assignee: KT & G CORPORATION, Daejeon (KR)

(21) Appl. No.: 18/572,418

(22) PCT Filed: Oct. 6, 2023
(86) PCT No.: PCT/KR2023/015373

§ 371 Date: Dec. 20, 2023

(30) Foreign Application Priority Data
Oct. 7, 2022 (KR) 10-2022-0129040

(51) Int. Cl. A24F 40/65; A24F 40/50; A24F 40/60; G06F 21/31; G06Q 20/32; G08B 7/06

(52) U.S. Cl. CPC A24F 40/65; A24F 40/50; A24F 40/60; G06F 21/31; G06Q 20/32; G08B 7/06

(57) ABSTRACT

The present disclosure provides an aerosol generating device used for payment of tobacco articles for aerosol generating devices, and a payment system using the same. An aerosol generating device according to an embodiment includes a heater, a battery configured to supply power to the heater, a communication unit configured to communicate with a seller terminal, and a controller configured to receive payment target tobacco article information from the communication unit, determine whether a payment target tobacco article is genuine based on the payment target tobacco article information, and transmit payment information to the seller terminal through the communication unit based on the payment target tobacco article being determined to be genuine.

### TECHNICAL FIELD

The present disclosure relates to an aerosol generating device and a payment system including the same.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, researches on a heating-type aerosol generating device have been actively conducted.

Meanwhile, as one of demands to make aerosol generating devices smarter and increase usability thereof, there is a demand for a payment system for tobacco articles used for aerosol generating devices.

### DISCLOSURE OF INVENTION

### Technical Problem

The present disclosure provides an aerosol generating device used for payment of tobacco articles used for aerosol generating devices and a payment system using the same.

### Solution to Problem

To solve the above technical objective, an aerosol generating device according to an embodiment of the present disclosure includes a heater, a battery configured to supply power to the heater, a communication unit configured to communicate with a seller terminal, and a controller configured to receive payment target tobacco article information from the communication unit, determine whether a payment target tobacco article is genuine, based on the payment target tobacco article information, and transmit payment information to the seller terminal through the communication unit based on the payment target tobacco article being determined to be genuine.

A system according to an embodiment includes an aerosol generating device and an external device configured to receive, from the aerosol generating device, device information about target tobacco articles compatible with the aerosol generating device, determine whether a payment target tobacco article of a seller terminal is genuine based on the device information, and payment information to the seller terminal based on the payment target tobacco article being determined to be genuine.

### Advantageous Effects of Invention

In an aerosol generating device and system according to an embodiment, it is checked whether a payment target tobacco article is genuine, and a payment is performed only if the payment target tobacco article is genuine. Thus, purchase and payment of a non-genuine tobacco article may be prevented.

In an aerosol generating device and system according to an embodiment, payment for tobacco article is made only if user authentication of the aerosol generating device is confirmed. Thus, payments for tobacco article purchases by unauthorized users, such as minors and the like, can be prevented.

### BRIEF DESCRIPTION OF DRAWINGS

FIGS. 1 to 3 are views illustrating examples in which a cigarette is inserted in an aerosol generating device according to an embodiment of the present disclosure.

FIGS. 4 and 5 are views illustrating examples of a cigarette according to an embodiment.

FIG. 6 is a block diagram of an aerosol generating device according to another embodiment.

FIG. 7 is a flowchart for explaining a payment method using an aerosol generating device, according to an embodiment.

FIGS. 8 to 10 are flowcharts for explaining a payment method of a system including an external device and an aerosol generating device according to embodiments.

### BEST MODE FOR CARRYING OUT THE INVENTION

According to an aspect of the present disclosure, an aerosol generating device includes a heater, a battery configured to supply power to the heater, a communication unit configured to communicate with a seller terminal, and a controller configured to receive payment target tobacco article information from the communication unit, determine whether a payment target tobacco article is genuine based on the payment target tobacco article information, and transmit payment information to the seller terminal through the communication unit based on the payment target tobacco article being determined to be genuine.

The communication unit may include a short-range communication module in the form of a chip or a tag, and the controller may be further configured to receive the payment target tobacco article information according to tagging of the short-range communication module and the seller terminal.

The communication unit may be further configured to switch the aerosol generating device from an inactivated state to an activated state based on communication with the external device through the communication unit.

The external device may include a user terminal configured to perform user authentication, and the controller may be further configured to receive a user authentication signal indicating that the user authentication is completed from the user terminal, and switch the aerosol generating device to the activated state, based on the user authentication signal.

The aerosol generating device may further include a user input unit configured to receive a user's input including user authentication information, and the controller may be further configured to switch the aerosol generating device to the activated state, based on the user authentication information.

The aerosol generating device may further include an output unit including at least one of a display, a speaker, a light emitting diode (LED), and a haptic motor, and the controller may be further configured to output, through the output unit, a result of determining whether the payment target tobacco article is genuine.

The aerosol generating device may further include a memory storing information about tobacco articles compatible with the aerosol generating device, and the controller may be further configured to determine whether the payment target tobacco article is genuine, by comparing the tobacco article information stored in the memory and the payment target tobacco article information.

A system according to an embodiment includes an aerosol generating device and an external device configured to receive, from the aerosol generating device, device information about target tobacco articles compatible with the aerosol generating device, determine whether a payment target tobacco article of a seller terminal is genuine based on the device information, and transmit payment information to the seller terminal based on the payment target tobacco article being determined to be genuine.

The external device may include a short-range communication module in the form of a chip or a tag, and the external device may receive information about a payment target tobacco article, according to tagging of the short-range communication module and the seller terminal.

The aerosol generating device may include a communication unit configured to communicate with the external device, and a controller configured to switch the aerosol generating device from an inactivated state to an activated state based on communication with the external device through the communication unit.

The external device may include a user terminal configured to perform user authentication, and the controller may be further configured to receive a user authentication signal indicating that the user authentication is completed from the user terminal, and switch the aerosol generating device to the activated state, based on the user authentication signal.

The aerosol generating device may include a user input unit configured to receive a user's input including user authentication information, and a controller configured to switch the aerosol generating device to an activated state, based on the user authentication information.

The external device may further include an output unit including at least one of a display, a speaker, a light emitting diode (LED), and a haptic motor, and may output, through the output unit, a result of determining whether the payment target tobacco article is genuine.

The external device may further include a memory storing the device information, and may determine whether the payment target tobacco article is genuine, by comparing the device information stored in the memory and the payment target tobacco article information.

### MODE FOR THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof. As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c. Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein. Hereinafter, embodiments of the present disclosure will be described in detail with reference to the drawings.

FIG. 1 through FIG. 3 are a diagram showing an example in which an aerosol generating article is inserted into an aerosol generating device.

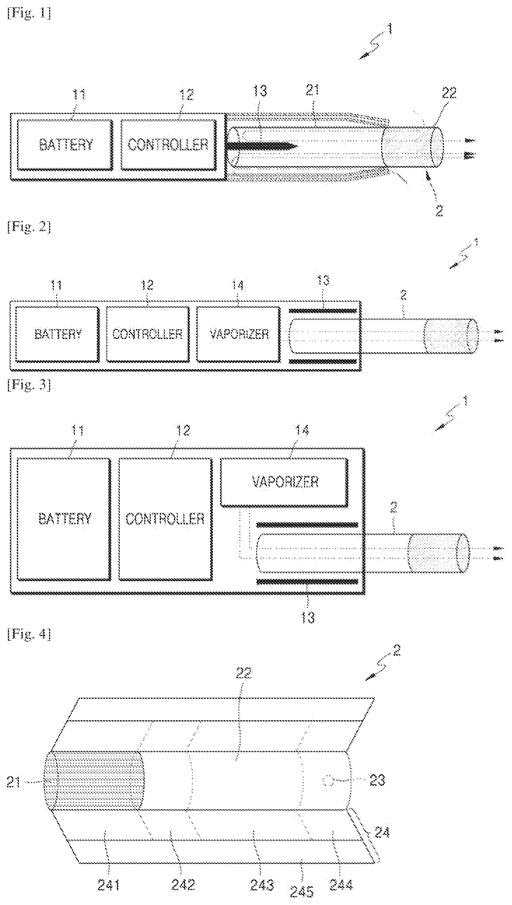

Referring to FIG. 1, the aerosol generating device 1 may include a battery 11, a controller 12, and a heater 13. Referring to FIGS. 2 and 3, the aerosol generating device 1 may further include a vaporizer 14. Also, the aerosol generating article 2 may be inserted into an inner space of the aerosol generating device 1.

FIG. 1 through FIG. 3 illustrate components of the aerosol generating device 1, which are related to the present embodiment. Therefore, it will be understood by one of ordinary skill in the art related to the present embodiment that other general-purpose components may be further included in the aerosol generating device 1, in addition to the components illustrated in FIG. 1 to FIG. 3. Also, FIGS. 2 and 3 illustrate that the aerosol generating device 1 includes the heater 13. However, as necessary, the heater 13 may be omitted.

FIG. 1 illustrates that the battery 11, the controller 12, and the heater 13 are arranged in series. Also, FIG. 2 illustrates that the battery 11, the controller 12, the vaporizer 14, and the heater 13 are arranged in series. Also, FIG. 3 illustrates that the vaporizer 14 and the heater 13 are arranged in parallel. However, the internal structure of the aerosol generating device 1 is not limited to the structures illustrated in FIGS. 1 to 3. In other words, according to the design of the aerosol generating device 1, the battery 11, the controller 12, the vaporizer 14, and the heater 13 may be differently arranged.

When the aerosol generating article 2 is inserted into the aerosol generating device 1, the aerosol generating device 1 may operate the heater 13 and/or the vaporizer 14 to generate aerosol from the heater 13 and/or the vaporizer 14. The aerosol generated by the heater 13 and/or the vaporizer 14 is delivered to a user by passing through the aerosol generating article 2.

As necessary, even when the aerosol generating article 2 is not inserted into the aerosol generating device 1, the aerosol generating device 1 may heat the heater 13.

The battery 11 may supply power to be used for the aerosol generating device 1 to operate. For example, the battery 11 may supply power to heat the heater 13, and may supply power for operating the controller 12. Also, the battery 11 may supply power for operations of a display, a sensor, a motor, etc. mounted in the aerosol generating device 1.

The controller 12 may generally control operations of the aerosol generating device 1. In detail, the controller 12 may control not only operations of the battery 11 and the heater 13, but also operations of other components included in the aerosol generating device 1. Also, the controller 12 may check a state of each of the components of the aerosol generating device 1 to determine whether or not the aerosol generating device 1 is able to operate.

The controller 12 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The heater 13 is heated by the power supplied from the battery 11. For example, when the aerosol generating article 2 is inserted into the aerosol generating device 1, the heater 13 may be located inside the aerosol generating article 2. Thus, the heated heater 13 may increase a temperature of an aerosol generating material in the aerosol generating article 2.

The heater 13 may include an electro-resistive heater. For example, the heater 13 may include an electrically conductive track, and the heater 13 may be heated when currents flow through the electrically conductive track. However, the heater 13 is not limited to the example described above and may include all heaters which may be heated to a desired temperature. Here, the desired temperature may be pre-set in the aerosol generating device 1 or may be set by a user.

As another example, the heater 13 may include an induction heater. In detail, the heater 13 may include an electrically conductive coil for heating an aerosol generating article in an induction heating method, and the aerosol generating article may include a susceptor which may be heated by the induction heater.

For example, the heater 13 may include a tube-type heating element, a plate-type heating element, a needle-type heating element, or a rod-type heating element, and may heat the inside or the outside of the aerosol generating article 2, according to the shape of the heating element.

Also, the aerosol generating device 1 may include a plurality of heaters 13. Here, the plurality of heaters 13 may be inserted into the aerosol generating article 2 or may be arranged outside the aerosol generating article 2. Also, some of the plurality of heaters 13 may be inserted into the aerosol generating article 2 and the others may be arranged outside the aerosol generating article 2. In addition, the shape of the heater 13 is not limited to the shape illustrated in FIG. 1 to 3, and may include various shapes.

The vaporizer 14 may generate aerosol by heating a liquid composition and the generated aerosol may pass through the aerosol generating article 2 to be delivered to a user. In other words, the aerosol generated via the vaporizer 14 may move along an air flow passage of the aerosol generating device 1 and the air flow passage may be configured such that the aerosol generated via the vaporizer 14 passes through the aerosol generating article 2 to be delivered to the user.

For example, the vaporizer 14 may include a liquid storage, a liquid delivery element, and a heating element, but it is not limited thereto. For example, the liquid storage, the liquid delivery element, and the heating element may be included in the aerosol generating device 1 as independent modules.

The liquid storage may store a liquid composition. For example, the liquid composition may be a liquid including a tobacco-containing material having a volatile tobacco flavor component, or a liquid including a non-tobacco material. The liquid storage may be formed to be detachable from the vaporizer 14 or may be formed integrally with the vaporizer 14.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 14 may be referred to as a cartomizer or an atomizer, but it is not limited thereto.

The aerosol generating device 1 may further include general-purpose components in addition to the battery 11, the controller 12, the heater 13, and the vaporizer 14. For example, the aerosol generating device 1 may include a display capable of outputting visual information and/or a motor for outputting haptic information. Also, the aerosol generating device 1 may include at least one sensor (a puff sensor, a temperature sensor, an aerosol generating article insertion detecting sensor, etc.). Also, the aerosol generating device 1 may be formed as a structure that, even when the aerosol generating article 2 is inserted into the aerosol generating device 1, may introduce external air or discharge internal air.

Although not illustrated in FIGS. 1 and 2, the aerosol generating device 1 and an additional cradle may form together a system. For example, the cradle may be used to charge the battery 11 of the aerosol generating device 1. Alternatively, the heater 13 may be heated when the cradle and the aerosol generating device 1 are coupled to each other.

The aerosol generating article 2 may be similar to a general combustive cigarette. For example, the aerosol generating article 2 may be divided into a first portion including an aerosol generating material and a second portion including a filter, etc. Alternatively, the second portion of the aerosol generating article 2 may also include an aerosol generating material. For example, an aerosol generating material made in the form of granules or capsules may be inserted into the second portion.

The first portion may be completely inserted into the aerosol generating device 1, and the second portion may be exposed to the outside. Alternatively, only a portion of the first portion may be inserted into the aerosol generating device 1, or a portion of the first portion and a portion of the second portion may be inserted thereinto. The user may puff aerosol while holding the second portion by the mouth of the user. In this case, the aerosol is generated by the external air passing through the first portion, and the generated aerosol passes through the second portion and is delivered to the user's mouth.

For example, the external air may flow into at least one air passage formed in the aerosol generating device 1. For example, opening and closing of the air passage and/or a size of the air passage formed in the aerosol generating device 1 may be adjusted by the user. Accordingly, the amount and the quality of smoking may be adjusted by the user. As another example, the external air may flow into the aerosol generating article 2 through at least one hole formed in a surface of the aerosol generating article 2.

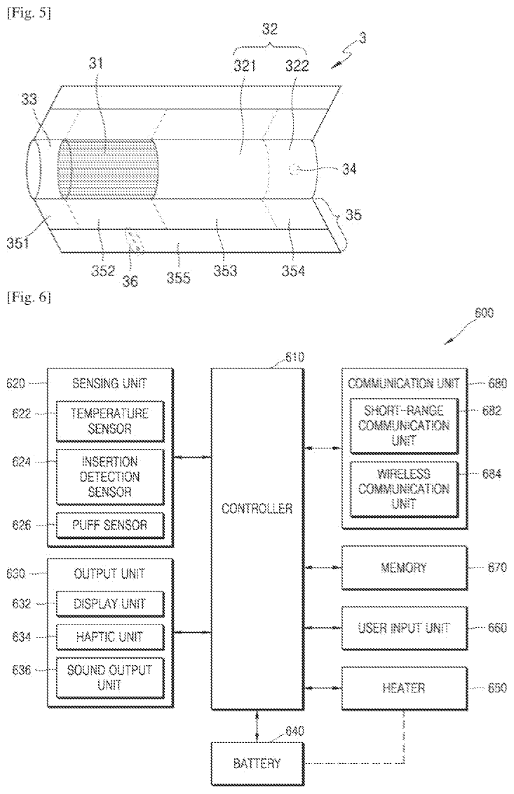

Hereinafter, examples of the aerosol generating article 2 will be described with reference to FIGS. 4 and 5.

FIGS. 4 and 5 illustrate examples of an aerosol generating article.

Referring to FIG. 4, the aerosol generating article 2 may include a tobacco rod 21 and a filter rod 22. The first portion described above with reference to FIGS. 1 through 3 may include the tobacco rod 21, and the second portion may include the filter rod 22.

FIG. 4 illustrates that the filter rod 22 includes a single segment. However, the filter rod 22 is not limited thereto. In other words, the filter rod 22 may include a plurality of segments. For example, the filter rod 22 may include a first segment configured to cool an aerosol and a second segment configured to filter a certain component included in the aerosol. Also, according to necessity, the filter rod 22 may further include at least one segment configured to perform other functions.

The diameter of the aerosol generating article 2 may be within the range of about 5 mm to about 9 mm and the length of the aerosol generating article 2 may be about 48 mm. However, the disclosure is not limited thereto. For example, the length of the tobacco rod 21 may be about 12 mm, the length of the first segment of the filter rod 22 may be about 10 mm, the length of the second segment of the filter rod 22 may be about 14 mm, and the length of the third segment of the filter rod 22 may be about 12 mm. However, disclosure is not limited thereto.

The aerosol generating article 2 may be packaged via at least one wrapper 24. The wrapper 24 may have at least one hole through which external air may be introduced or internal air may be discharged. For example, the aerosol generating article 2 may be packaged via one wrapper 24. As another example, the aerosol generating article 2 may be doubly packaged via at least two wrappers 24. For example, the tobacco rod 21 may be packaged via a first wrapper 241, and the filter rod 22 may be packaged via second wrappers 242, 243, and 244. Also, the entire aerosol generating article 2 may be packaged via a single wrapper 245. When the filter rod 22 includes a plurality of segments, each segment may be packaged via each of the second wrappers 242, 243, and 244.

The first wrapper 241 and the second wrapper 242 may each include general filter wrapping paper. For example, the first wrapper 241 and the second wrapper 242 may each include porous wrapping paper or non-porous wrapping paper. In addition, the first wrapper 241 and the second wrapper 242 may each include paper having oil resistance and/or an aluminum laminate packaging material.

The third wrapper 243 may include hard wrapping paper. For example, the basis weight of the third wrapper 243 may be in the range of about 88 g/m2 to about 96 g/m2, specifically in the range of about 90 g/m2 to about 94 g/m2. In addition, the thickness of the third wrapper 243 may be in the range of about 120 um to about 130 um, specifically 125 um.

The fourth wrapper 244 may include oil-resistant hard wrapping paper. For example, the basis weight of the fourth wrapper 244 may be in the range of about 88 g/m2 to about 96 g/m2, specifically in the range of about 90 g/m2 to about 94 g/m2. In addition, the thickness of the fourth wrapper 244 may be in the range of about 120 um to about 130 um, specifically 125 um.

The fifth wrapper 245 may include sterile paper (MFW). Here, the sterile paper (MFW) refers to a paper specially prepared so that tensile strength, water resistance, smoothness, etc. thereof are further improved compared to those of general paper. For example, the basis weight of the fifth wrapper 245 may be in the range of about 57 g/m2 to about 63 g/m2, specifically 60 g/m2. In addition, the thickness of the fifth wrapper 245 may be in the range of about 64 um to about 70 um, specifically 67 um.

A certain material may be internally added to the fifth wrapper 245. Here, an example of the certain material may include silicon, but is not limited thereto. For example, silicon has characteristics, such as heat resistance with little change with temperature, resistance to oxidation, resistance to various chemicals, water repellency against water, or electrical insulation. However, even though the certain material is not silicon, any material having the characteristics described above may be applied to (or coated on) the fifth wrapper 245 without limitation.

The fifth wrapper 245 may prevent the aerosol generating article 2 from burning. For example, when the tobacco rod 21 is heated by the heater 13, there is a possibility that the aerosol generating article 2 is burned. Specifically, when the temperature rises above the ignition point of any one of the materials included in the tobacco rod 21, the aerosol generating article 2 may be burned. Even in this case, because the fifth wrapper 245 includes a non-combustible material, a burning phenomenon of the aerosol generating article 2 may be prevented.

In addition, the fifth wrapper 245 may prevent a holder 1 from being contaminated by substances generated in the aerosol generating article 2. By a user's puff, liquid substances may be generated in the aerosol generating article 2. For example, as an aerosol generated in the aerosol generating article 2 is cooled by the outside air, liquid substances (e.g., moisture, etc.) may be generated. As the fifth wrapper 245 wraps the aerosol generating article 2, the liquid substances generated in the aerosol generating article 2 may be prevented from leaking out of the aerosol generating article 2.

The tobacco rod 21 includes an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be formed in various ways. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat-conducting material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod 21 may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may include a cellulose acetate filter. For example, the first segment may include a tube-shaped structure including a hollow therein. When the heater 13 is inserted by the first segment, the inner material of the tobacco rod 21 may be prevented from being pushed back, and a cooling effect of the aerosol may occur. The diameter of the hollow included in the first segment may be an appropriate diameter within the range of about 2 mm to about 4.5 mm, but is not limited thereto.

The length of the first segment may be an appropriate length within the range of about 4 mm to about 30 mm, but is not limited thereto. Specifically, the length of the first segment may be 10 mm, but is not limited thereto.

The hardness of the first segment may be adjusted by adjusting the content of a plasticizer in the manufacture of the first segment. In addition, the first segment may be manufactured by inserting a structure, such as a film or a tube including the same material or different materials, inside the first segment (e.g., into the hollow).

The second segment of the filter rod 22 cools the aerosol generated as the heater 13 heats the tobacco rod 21. Thus, a user may inhale the aerosol cooled to a suitable temperature.

The length or diameter of the second segment may be variously determined according to the shape of the aerosol generating article 2. For example, the length of the second segment may be appropriately determined within the range of about 7 mm to about 20 mm. Specifically, the length of the second segment may be about 14 mm, but is not limited thereto.

The second segment may be fabricated by weaving polymer fibers. In this case, a flavored liquid may be applied to fibers made of polymer. Alternatively, the second segment may be fabricated by weaving a fiber to which a flavored liquid is applied and a fiber made of a polymer together. Alternatively, the second segment may be formed by a crimped polymer sheet.

For example, the polymer may include a material selected from the group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed by a woven polymer fiber or crimped polymer sheet, the second segment may include a single channel or a plurality of channels extending in a longitudinal direction thereof. Here, the channel refers to a passage through which a gas (e.g., air or aerosol) passes.

For example, the second segment formed by the crimped polymer sheet may be formed from a material having a thickness between about 5 μm and about 300 μm, such as between about 10 μm and about 250 μm. Also, the total surface area of the second segment may be between about 300 mm2/mm and about 1000 mm2/mm. Furthermore, an aerosol cooling element may be formed from a material having a specific surface area between about 10 mm2/mg and about 100 mm2/mg.

The second segment may include a thread containing a volatile flavor ingredient. Here, the volatile flavor ingredient may be menthol, but is not limited thereto. For example, the thread may be filled with a sufficient amount of menthol to provide 1.5 mg or more of menthol to the second segment.

The third segment of the filter rod 22 may include a cellulose acetate filter. The length of the third segment may be appropriately determined within the range of about 4 mm to about 20 mm. For example, the length of the third segment may be about 12 mm, but is not limited thereto.

The third segment may be fabricated such that flavor is generated by spraying a flavored liquid on the third segment in the process of fabricating the third segment. Alternatively, a separate fiber to which a flavored liquid is applied may be inserted into the third segment. The aerosol generated by the tobacco rod 21 is cooled as the aerosol passes through the second segment of the filter rod 22, and the cooled aerosol is delivered to a user through the third segment. Accordingly, when a flavoring element is added to the third segment, an effect of enhancing the durability of a flavor delivered to the user may occur.

Also, the filter rod 22 may include at least one capsule 23. Here, the capsule 23 may generate a flavor or an aerosol. For example, the capsule 23 may have a configuration in which a liquid containing a flavoring material is wrapped with a film. For example, the capsule 23 may have a spherical or cylindrical shape, but is not limited thereto.

Referring to FIG. 5, the aerosol generating article 2 may further include a front-end filter 33 that is a front-end plug. The front-end filter 33 may be located on a side of the tobacco rod 21, the side facing the filter rod 22. The front-end filter 33 may prevent the tobacco rod 31 from being detached outwards and prevent a liquefied aerosol from flowing into the aerosol-generating device 1 (FIGS. 1 through 3) from the tobacco rod 21, during smoking.

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

The total length and diameter of the cigarette 3 may correspond to the total length and diameter of the aerosol generating article 2 of FIG. 4. For example, the length of the front-end filter 33 may be about 7 mm, the length of the tobacco rod 31 may be about 15 mm, the length of the first segment 321 may be about 12 mm, and the length of the first segment 322 may be about 14 mm, but the embodiments are not limited thereto.

The cigarette 3 may be packaged via at least one wrapper 35. The wrapper 35 may have at least one hole through which external air may be introduced or internal air may be discharged. For example, the front-end filter 33 may be packaged via a first wrapper 351, the filter rod 31 may be packaged via a second wrapper 352, the first segment 321 may be packaged via a third wrapper 353, and the second segment 322 may be packaged via a fourth wrapper 354. Additionally, a whole part of the cigarette 3 may be packaged by a fifth wrapper 355.

Also, the fifth wrapper 355 may have at least one through hole 36. For example, the through hole 36 may be formed at a portion of the fifth wrapper 355 surrounding the tobacco rod 31. The through hole 36 may perform a function of transmitting heat generated by the heater 31 shown in FIGS. 2 and 3 to the inside of the tobacco rod 31.

Also, the second segment 322 may include at least one capsule 34. Here, the capsule 34 may perform a function of generating a flavor or another function of generating aerosol. For example, the capsule 34 may have a configuration in which a liquid containing a flavoring material is wrapped with a film. For example, the capsule 34 may have a spherical or cylindrical shape, but is not limited thereto.

The first wrapper 351 may include general filter wrapping paper to which a metal foil such as an aluminum foil is coupled. For example, the total thickness of the first wrapper 351 may be in the range of about 45 um to about 55 um, specifically 50.3 um. In addition, the thickness of the metal foil of the first wrapper 351 may be in the range of about 6 um to about 7 um, specifically 6.3 um. In addition, the basis weight of the first wrapper 351 may be in the range of about 50 g/m2 to about 55 g/m2, specifically 53 g/m2.

The second wrapper 352 and the third wrapper 353 may each include general filter wrapping paper. For example, the second wrapper 352 and the third wrapper 353 may each include porous wrapping paper or non-porous wrapping paper.

For example, the porosity of the second wrapper 352 may be 35,000 CU, but is not limited thereto. In addition, the thickness of the second wrapper 352 may be in the range of about 70 um to about 80 um, specifically 78 um. In addition, the basis weight of the second wrapper 352 may be in the range of about 20 g/m2 to about 25 g/m2, specifically 23.5 g/m2.

For example, the porosity of the third wrapper 353 may be 24,000 CU, but is not limited thereto. In addition, the thickness of the third wrapper 353 may be in the range of about 60 um to about 70 um, specifically 68 um. In addition, the basis weight of the third wrapper 353 may be in the range of about 20 g/m2 to about 25 g/m2, specifically 21 g/m2.

The fourth wrapper 354 may include PLA laminated paper. Here, the PLA laminated paper refers to a three-ply paper including a paper layer, a PLA layer, and a paper layer. For example, the thickness of the fourth wrapper 354 may be in the range of about 100 um to about 120 um, specifically 110 um. In addition, the basis weight of the fourth wrapper 354 may be in the range of about 80 g/m2 to about 100 g/m2, specifically 88 g/m2.

The fifth wrapper 355 may include sterilized paper (MFW). Here, the sterile paper (MFW) refers to a paper specially prepared so that tensile strength, water resistance, smoothness, etc. thereof are further improved compared to those of general paper. For example, the basis weight of the fifth wrapper 355 may be in the range of about 57 g/m2 to about 63 g/m2, specifically 60 g/m2. In addition, the thickness of the fifth wrapper 355 may be in the range of about 64 um to about 70 um, specifically 67 um.

A certain material may be internally added to the fifth wrapper 355. Here, an example of the certain material may include, but is not limited thereto. For example, silicon has characteristics, such as heat resistance with little change with temperature, resistance to oxidation, resistance to various chemicals, water repellency against water, or electrical insulation. However, even though the certain material is not silicon, any material having the characteristics described above may be applied to (or coated on) the fifth wrapper 355 without limitation.

The shear plug 33 may include cellulose acetate. As an example, the front-end filter 33 may be fabricated by adding a plasticizer (e.g., triacetin) to a cellulose acetate tow. The mono denier of a filament constituting the cellulose acetate tow may be in the range of about 1.0 to about 10.0, specifically in the range of about 4.0 to about 6.0. More specifically, the mono denier of the filament of the front-end filter 33 may be 5.0. In addition, the cross-section of the filament constituting the front-end filter 33 may have a Y-shape. The total denier of the front-end filter 33 may be in the range of about 20,000 to about 30,000, preferably in the range of about 25,000 to about 30,000. More specifically, the total denier of the front-end filter 33 may be 28,000.

In addition, if necessary, the front-end filter 33 may include at least one channel, and the cross-section of the channel may have various shapes.

The tobacco rod 31 may correspond to the tobacco rod 21 described above with reference to FIG. 4. Therefore, a detailed description of the tobacco rod 31 is omitted below.

The first segment 321 may include cellulose acetate. For example, the first segment may include a tube-shaped structure including a hollow therein. The first segment 321 may be fabricated by adding a plasticizer (e.g., triacetin) to the cellulose acetate tow. For example, the mono denier and total denier of the first segment 321 may be the same as the mono denier and total denier of the front-end filter 33.

The second segment 322 may include cellulose acetate. The mono denier of a filament constituting the second segment 322 may be in the range of about 1.0 to about 10.0, specifically in the range of about 8.0 to about 10.0. More specifically, the mono denier of the filament of the second segment 322 may be 9.0. In addition, the cross-section of the filament of the second segment 322 may have a Y-shape. The total denier of the second segment 322 may be in the range of about 20,000 to about 30,000, specifically 25,000.

FIG. 6 is a block diagram of an aerosol generating device 600 according to another embodiment.

The aerosol generating device 600 may include a controller 610, a sensing unit 620, an output unit 630, a battery 640, a heater 650, a user input unit 660, a memory 670, and a communication unit 680. However, the internal structure of the aerosol generating device 600 is not limited to those illustrated in FIG. 6. That is, according to the design of the aerosol generating device 600, it will be understood by one of ordinary skill in the art that some of the components shown in FIG. 6 may be omitted or new components may be added.

The sensing unit 620 may sense a state of the aerosol generating device 600 and a state around the aerosol generating device 600, and transmit sensed information to the controller 610. Based on the sensed information, the controller 610 may control the aerosol generating device 600 to perform various functions, such as controlling an operation of the heater 650, limiting smoking, determining whether an aerosol generating article (e.g., a cigarette, a cartridge, or the like) is inserted, displaying a notification, or the like.

The sensing unit 620 may include at least one of a temperature sensor 622, an insertion detection sensor, and a puff sensor 626, but is not limited thereto.

The temperature sensor 622 may sense a temperature at which the heater 650 (or an aerosol generating material) is heated. The aerosol generating device 600 may include a separate temperature sensor for sensing the temperature of the heater 650, or the heater 650 may serve as a temperature sensor. Alternatively, the temperature sensor 622 may also be arranged around the battery 640 to monitor the temperature of the battery 640.

The insertion detection sensor 624 may sense insertion and/or removal of an aerosol generating article. For example, the insertion detection sensor 624 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 626 may sense a user's puff on the basis of various physical changes in an airflow passage or an airflow channel. For example, the puff sensor 626 may sense a user's puff on the basis of any one of a temperature change, a flow change, a voltage change, and a pressure change.

The sensing unit 620 may include, in addition to the temperature sensor 622, the insertion detection sensor 624, and the puff sensor 626 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 630 may include at least one of a display unit 632, a haptic unit 634, and a sound output unit 636, but is not limited thereto. When the display unit 632 and a touch pad form a layered structure to form a touch screen, the display unit 632 may also be used as an input device in addition to an output device.

The display unit 632 may visually provide information about the aerosol generating device 600 to the user. For example, information about the aerosol generating device 600 may mean various pieces of information, such as a charging/discharging state of the battery 640 of the aerosol generating device 600, a preheating state of the heater 650, an insertion/removal state of an aerosol generating article, or a state in which the use of the aerosol generating device 600 is restricted (e.g., sensing of an abnormal object), or the like, and the display unit 632 may output the information to the outside. The display unit 632 may be, for example, a liquid crystal display panel (LCD), an organic light-emitting diode (OLED) display panel, or the like. In addition, the display unit 632 may be in the form of a light-emitting diode (LED) light-emitting device.

The haptic unit 634 may tactilely provide information about the aerosol generating device 600 to the user by converting an electrical signal into a mechanical stimulus or an electrical stimulus. For example, the haptic unit 634 may include a motor, a piezoelectric element, or an electrical stimulation device.

The sound output unit 636 may audibly provide information about the aerosol generating device 600 to the user. For example, the sound output unit 636 may convert an electrical signal into a sound signal and output the same to the outside.

The battery 640 may supply power used to operate the aerosol generating device 600. The battery 640 may supply power such that the heater 650 may be heated. In addition, the battery 640 may supply power required for operations of other components (e.g., the sensing unit 620, the output unit 630, the user input unit 660, the memory 670, and the communication unit 680) in the aerosol generating device 600. The battery 640 may be a rechargeable battery or a disposable battery. For example, the battery 640 may be a lithium polymer (LiPoly) battery, but is not limited thereto.

The heater 650 may receive power from the battery 640 to heat an aerosol generating material. Although not illustrated in FIG. 6, the aerosol generating device 600 may further include a power conversion circuit (e.g., a direct current (DC)/DC converter) that converts power of the battery 640 and supplies the same to the heater 650. In addition, when the aerosol generating device 600 generates aerosols in an induction heating method, the aerosol generating device 600 may further include a DC/alternating current (AC) that converts DC power of the battery 640 into AC power.

The controller 610, the sensing unit 620, the output unit 630, the user input unit 660, the memory 670, and the communication unit 680 may each receive power from the battery 640 to perform a function. Although not illustrated in FIG. 6, the aerosol generating device 600 may further include a power conversion circuit that converts power of the battery 640 to supply the power to respective components, for example, a low dropout (LDO) circuit, or a voltage regulator circuit.

In an embodiment, the heater 650 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 650 may be implemented by a metal wire, a metal plate on which an electrically conductive track is arranged, a ceramic heating element, or the like, but is not limited thereto.

In another embodiment, the heater 650 may be a heater of an induction heating type. For example, the heater 650 may include a susceptor that heats an aerosol generating material by generating heat through a magnetic field applied by a coil.

The user input unit 660 may receive information input from the user or may output information to the user. For example, the user input unit 660 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 6, the aerosol generating device 600 may further include a connection interface, such as a universal serial bus (USB) interface, and may connect to other external devices through the connection interface, such as the USB interface, to transmit and receive information, or to charge the battery 640.

The user input unit 660 may configure a user authentication unit for obtaining user authentication information. The user may input personal information to the user input unit 660. The aerosol generating device 600 may obtain user's personal information through the user input unit 660, and perform user authentication. When the user input unit 660 includes a biometric sensor, the user may input one's biometric information (e.g., a fingerprint). The aerosol generating device 600 may obtain user's biometric information though the user input unit 660, and perform user authentication.

The memory 670 is a hardware component that stores various types of data processed in the aerosol generating device 600, and may store data processed and data to be processed by the controller 610. The memory 670 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 670 may store an operation time of the aerosol generating device 600, the maximum number of puffs, the current number of puffs, at least one temperature profile, data on a user's smoking pattern, etc. The memory 670 may store user authentication information obtained by receiving the user input. The memory 670 may store information about a tobacco article that is compatible with the aerosol generating device 600.

The communication unit 680 may include at least one component for communication with another electronic device. For example, the communication unit 680 may include a short-range wireless communication unit 682 and a wireless communication unit 684.

The short-range wireless communication unit 682 may include a Bluetooth communication unit, a Bluetooth Low Energy (BLE) communication unit, a near field communication (NFC) unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 684 may include a cellular network communication unit, an Internet communication unit, a computer network (e.g., local area network (LAN) or wide area network (WAN)) communication unit, or the like, but is not limited thereto. The wireless communication unit 684 may check and authenticate the aerosol generating device 600 in a communication network by using subscriber information (e.g.: international mobile subscriber identity (IMSI)).

The controller 610 may control general operations of the aerosol generating device 600. In an embodiment, the controller 610 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 610 may control the temperature of the heater 650 by controlling supply of power of the battery 640 to the heater 650. For example, the controller 610 may control power supply by controlling switching of a switching element between the battery 640 and the heater 650. In another example, a direct heating circuit may also control power supply to the heater 650 according to a control command of the controller 610.

The controller 610 may analyze a result sensed by the sensing unit 620 and control subsequent processes to be performed. For example, the controller 610 may control power supplied to the heater 650 to start or end an operation of the heater 650 on the basis of a result sensed by the sensing unit 620. As another example, the controller 610 may control, based on a result sensed by the sensing unit 620, an amount of power supplied to the heater 650 and the time the power is supplied, such that the heater 650 may be heated to a certain temperature or maintained at an appropriate temperature.

The controller 610 may control the output unit 630 on the basis of a result sensed by the sensing unit 620. For example, when the number of puffs counted through the puff sensor 626 reaches a preset number, the controller 610 may notify the user that the aerosol generating device 600 will soon be terminated through at least one of the display unit 632, the haptic unit 634, and the sound output unit 636.

Aerosol generating devices are becoming more popular. Accordingly, there is a growing need to make aerosol generating devices smarter and increase their usability. As one of the demands, there is a demand for a payment system for consumables used in the aerosol generating devices.

The aerosol generating device may be communicatively connected to various external devices through the communication unit 680. The external device may be a user terminal using the aerosol generating device including a mobile terminal, a smart phone, and the like. Furthermore, the aerosol generating device may be communicatively connected to a seller terminal through the communication unit 680. The seller terminal may be an NFC enabled point of sales (POS) terminal located in a seller store or at a vending machine.

As the aerosol generating device is communicatively connected to the seller terminal, and furthermore, communicatively connected to external devices such as smart phones and the like, a consumables payment system used for an aerosol generating device may be established by using an aerosol generating device.

Meanwhile, the aerosol generating device and consumables used for the aerosol generating device may be subject to certain restrictions, including age restrictions. In some countries, purchase and use of aerosol generating devices and consumables are restricted based on user age. Furthermore, when consumables used in an aerosol generating device are not compatible with the aerosol generating device or are not genuine, the consumables may not be heated in the aerosol generating device or use thereof may be restricted.

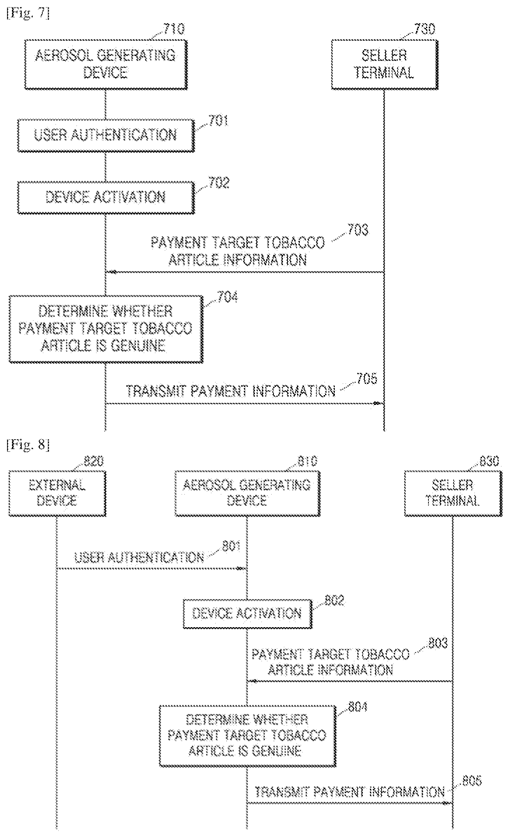

Accordingly, in the payment system using the aerosol generating device, there is a need to consider these particularities. In the following description, a payment method using an aerosol generating device is described with reference to FIGS. 7 to 10.

The tobacco article illustrated in FIGS. 7 to 10 are consumables inserted in an aerosol generating device to generate aerosol, and may correspond to the aerosol generating article, cigarette, and cartridge of FIGS. 1 to 6.

FIG. 7 is a flowchart for explaining a payment method using an aerosol generating device according to an embodiment.

In operation 701, the aerosol generating device receives a user's input to obtain user authentication information. A user may input user's personal information or user's biometric information (e.g., a fingerprint) to a user input unit, and the aerosol generating device may obtain user's personal information or biometric information through the user input unit and perform user authentication.

Initially, the aerosol generating device may be in a locked state in which some functions including a payment function are inactivated, to prevent illegal use by minors, etc. In operation 702, the controller of the aerosol generating device switches the state of the aerosol generating device from the locking state in which the aerosol generating device is inactivated to an activated state, based on the user authentication information. The payment function of the aerosol generating device may be operable in the activated state.

In operation 703, a seller terminal transmits information about a payment target tobacco article to the aerosol generating device. The seller terminal may be an NFC enabled point of sales (POS) terminal located in the seller store or at a vending machine. The controller of the aerosol generating device may receive the payment target tobacco article information according to tagging between the short-range communication module of the aerosol generating device and the seller terminal. For example, the payment target tobacco article information may be transmitted when a user taps the aerosol generating device on the seller terminal.

In operation 704, the controller of the aerosol generating device determines whether a payment target tobacco article is genuine based on the payment target tobacco article information. In the present disclosure, being “genuine” refers to a broad concept of being compatible with an aerosol generating device. In this regard, the genuine tobacco article does not necessarily have to be manufactured by the same manufacturer of an aerosol generating device and may include a tobacco article manufactured by another manufacturer.

The controller of the aerosol generating device may determine whether the payment target tobacco article is genuine, by matching information about a tobacco article stored in the memory and the payment target tobacco article information with each other. For example, whether the tobacco article is genuine may be determined by using a manufacturer, a product name, a product serial number, and the like included in the tobacco article information. A tobacco article that is not genuine may mean, for example, tobacco articles that are not compatible with the aerosol generating device, tobacco articles that are not manufactured/sold by the manufacturer of the aerosol generating device, and the like, but the present disclosure is not limited thereto. When the payment target tobacco article is determined not to be genuine, in order to prevent payment at the seller terminal, the processor may not transmit payment information to the seller terminal.

The controller of the aerosol generating device may output, through the output unit, a result of determining whether the payment target article is genuine. The output unit may provide a user with information about the result of determining whether the payment target article is genuine, through at least one of the means of visual, auditory, or tactile feedback. For example, the output unit may provide text, such as “GENUINE CONFIRMED,” “NOT GENUINE,” “PAYMENT IMPOSSIBLE,” or the like.

In operation 705, when the controller of the aerosol generating device determines that the payment target tobacco article is genuine, payment information is transmitted to enable payment at the seller terminal. Examples of the payment information, which is information needed for payment, may include a card number, a card company information, user information, card validity period information, a card password, and the like.

The controller of the aerosol generating device may output, through the output unit, a result of transmitting the payment information. The output unit may provide a user with information about the result of transmitting payment information through at least one of the means of visual, auditory, or tactile feedback. For example, the output unit may provide text such as “PAYMENT COMPLETED” and the like.

FIG. 8 is a flowchart for explaining a payment method of a system including an external device and an aerosol generating device, according to an embodiment.

In operation 801, the aerosol generating device may obtain user authentication information through an external device communicatively connected to the aerosol generating device.

The external device may include a user terminal that performs user authentication. The user terminal may be a mobile terminal or smart phone that the user carries. For example, in order to purchase an aerosol generating device, user authentication or age verification is performed at the user terminal. To this end, a user authentication application is executed in the user terminal, and user authentication information is input through the user authentication application. If user authentication or age verification is successfully completed based on the user authentication information, the user terminal transmits a user authentication signal to the aerosol generating device. The controller of the aerosol generating device, when receiving the user authentication signal, activates the aerosol generating device. Various authentication methods, for example, I-pin authentication, telephone number authentication, public certificate authentication, biometric information authentication, and the like may be used for the user authentication of the user terminal, but the disclosure is not limited to the above methods. Furthermore, when an aerosol generating device is purchased at a store, user authentication or age verification may be performed by transceiving the authentication number issued by the store with the user terminal.

In operation 802, the controller of the aerosol generating device switches the aerosol generating device from the inactivated locking state to the activated state based on the user authentication signal.

In an embodiment, the controller of the aerosol generating device may establish a communication network with the external device through the communication unit, and switch the aerosol generating device from the inactivated state to the activated state.

The controller of the aerosol generating device may receive a user authentication signal from the external device, and switch the aerosol generating device to the activated state based on the user authentication signal.

As operations 803 to 805 are similar to the operations 703 to 705 of FIG. 7, descriptions thereof are omitted. In another embodiment, the external device 820 may transmit the user authentication information to the aerosol generating device 810, and the user authentication may be performed based on the user authentication information by the aerosol generating device 810.

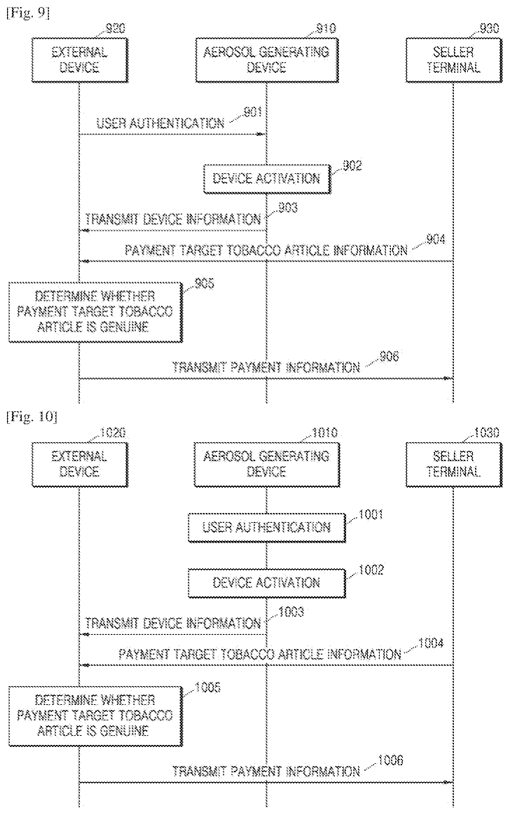

FIG. 9 is a flowchart for explaining a payment method of a system including an external device and an aerosol generating device, according to another embodiment.

In operations 901 and 902, user authentication is performed, and the aerosol generating device is switched to the activated state, which are similar to those of FIG. 8 and thus detailed descriptions thereof are omitted.

In operation 903, the aerosol generating device transmits device information to the external device. The device information may include information about tobacco articles compatible with the aerosol generating device.

In operation 904, the seller terminal transmits information about a payment target tobacco article to the external device. The external device and the seller terminal may be communicatively connected to each other through NFC tagging.

In operation 905, an application installed in the external device determines whether the payment target tobacco article received from the seller terminal is genuine, based on the device information received from the aerosol generating device. The application may determine whether the payment target tobacco article is genuine by comparing the device information (i.e., information about the tobacco articles compatible with the aerosol generating device) and the payment target tobacco article information. The information about the tobacco articles compatible with the aerosol generating device may be included in the device information received from the aerosol generating device.

In an embodiment, the external device may include a memory. The memory may store the device information received from the aerosol generating device, and the device information may include the information about the tobacco articles compatible with the aerosol generating device. The application may determine whether the payment target article is genuine by comparing the device information (i.e., information about the compatible tobacco articles) stored in the memory and the payment target tobacco article information.

In an embodiment, the external device may include an output unit including at least one of a display, a speaker, an LED, and a haptic motor, and the application may output, through the output unit, a result of determining whether the payment target article is genuine. The output unit may provide a user with information about the result of determining whether the payment target article is genuine, through at least one of the means of visual, auditory, or tactile feedback. For example, the output unit may provide text, such as “GENUINE CONFIRMED,” “NOT GENUINE.” “PAYMENT IMPOSSIBLE,” or the like.

In operation 906, when the application of the external device determines that the payment target tobacco article is genuine, payment information is transmitted to enable payment at the seller terminal The payment information, which is information needed for payment, may include a card number, a card company information, user information, card validity period information, a card password, and the like.

The application of the external device may output, through the output unit, a result of transmitting the payment information. The output unit may provide a user with information about the result of transmitting payment information through at least one of the means of visual, auditory, or tactile feedback. For example, the output unit may provide text such as “PAYMENT COMPLETED” and the like.

FIG. 10 is a flowchart for explaining a payment method of a system including an external device and an aerosol generating device, according to another embodiment.

Operation 1001 is an operation in which the aerosol generating device receives a user's input and obtains user authentication information, and operation 1002 is an operation in which the aerosol generating device is switched to the activated state, which are respectively similar to the operation 701 and operation 702 of FIG. 7, and thus, detailed descriptions thereof are omitted.

As operation 1003 to operation 1006 are respectively similar to the operation 9003 to operation 9006 of FIG. 9, detailed descriptions thereof are omitted.

As described above, in the aerosol generating device and system according to an embodiment, it is checked whether a payment target tobacco article is genuine, and payment is made only if the payment target tobacco article is genuine. Accordingly, purchase and payment of a non-genuine tobacco article may be prevented.

In an aerosol generating device and system according to an embodiment, payment is made only if user authentication is completed. Thus, payments for tobacco article purchases by unauthorized users, such as minors and the like, can be prevented.

An embodiment of the present disclosure may be embodied in the form of a recording medium including computer executable instructions, such as a program module executed by a computer. A computer-readable storage medium may be a useable medium that is accessible by a computer and may include all of volatile and non-volatile media and separable and inseparable media. Furthermore, the computer-readable medium may include all of computer storage media and communication media. The computer storage media may include all of volatile and non-volatile media and separable and inseparable media, which are embodied by a certain method or technology for storing information such as computer-readable instructions, data structures, program modules, or other data. The communication media may typically include computer-readable instructions, data structures, program modules, or other data of a modulated data signal such as a carrier wave, or other transmission mechanism, and may also include information transmission media.

In the above, although embodiments have been described, these are merely exemplary, and those skilled in the art to which the present disclosure pertains could make various modifications and changes from these descriptions. Therefore, it will be understood by those of ordinary skill in the art that various changes in form and details may be made therein without departing from the spirit and scope of the present disclosure as defined by the following claims.

1. An aerosol generating device comprising:
a heater;
a battery configured to supply power to the heater;
a communication unit configured to communicate with a seller terminal; and
a controller configured to receive payment target tobacco article information from the communication unit, determine whether a payment target tobacco article is genuine based on the payment target tobacco article information, and transmit payment information to the seller terminal through the communication unit based on the payment target tobacco article being determined to be genuine.

2. The aerosol generating device of claim 1, wherein
the communication unit comprises a short-range communication module in a form of a chip or a tag, and
the controller is further configured to receive the payment target tobacco article information through tagging of the short-range communication module and the seller terminal.

3. The aerosol generating device of claim 1, wherein
the communication unit is further configured to communicate with an external device, and
the controller is further configured to switch the aerosol generating device from an inactivated state to an activated state based on communication with the external device through the communication unit.

4. The aerosol generating device of claim 3, wherein
the external device comprises a user terminal configured to perform user authentication, and
the controller is further configured to receive a user authentication signal indicating that the user authentication is completed from the user terminal, and switch the aerosol generating device to the activated state based on the user authentication signal.

5. The aerosol generating device of claim 1, further comprising a user input unit configured to receive a user's input including user authentication information,
wherein the controller is further configured to switch the aerosol generating device to an activated state based on the user authentication information.

6. The aerosol generating device of claim 1, further comprising an output unit comprising at least one of a display, a speaker, a light emitting diode (LED), and a haptic motor,
wherein the controller is further configured to output, through the output unit, a result of determining whether the payment target tobacco article is genuine.

7. The aerosol generating device of claim 1, further comprising a memory storing information about tobacco articles compatible with the aerosol generating device,
wherein the controller is further configured to determine whether the payment target tobacco article is genuine by comparing the tobacco article information stored in the memory and the payment target tobacco article information.

8. A system comprising:
an aerosol generating device; and
an external device configured to:
receive, from the aerosol generating device, device information about target tobacco articles compatible with the aerosol generating device, determine whether a payment target tobacco article of a seller terminal is genuine based on the device information, and
transmit payment information to the seller terminal based on the payment target tobacco article being determined to be genuine.

9. The system of claim 8, wherein
the external device comprises a short-range communication module in a form of a chip or a tag, and
the external device is further configured to receive information about the payment target tobacco article according to tagging of the short-range communication module and the seller terminal.

10. The system of claim 8, wherein the aerosol generating device comprises:
a communication unit configured to communicate with the external device; and
a controller configured to switch the aerosol generating device from an inactivated state to an activated state based on communication with the external device through the communication unit.

11. The system of claim 10, wherein the external device comprises a user terminal configured to perform user authentication, and
the controller is further configured to receive a user authentication signal indicating that the user authentication is completed from the user terminal, and switch the aerosol generating device to an activated state, based on the user authentication signal.

12. The system of claim 8, wherein the aerosol generating device comprises:
a user input unit configured to receive a user's input including user authentication information; and
a controller configured to switch the aerosol generating device to an activated state based on the user authentication information.

13. The system of claim 8, wherein the external device further comprises an output unit comprising at least one of a display, a speaker, a light emitting diode (LED), and a haptic motor, and outputs, through the output unit, a result of determining whether the payment target tobacco article is genuine.

14. The system of claim 8, wherein the external device further comprises a memory storing the device information, and determines whether the payment target tobacco article is genuine by comparing the device information stored in the memory and the payment target tobacco article information.
